(19) United States
(12) Patent Application Publication
(10) Pub. No.: US 2024/0154527 A1
(43) Pub. Date: May 9, 2024

(54) QUICK-CHARGE VOLTAGE BOOSTER CIRCUIT FOR HEATING

(71) Applicant: Rui ZHANG, Suzhou (CN)

(72) Inventors: Rui ZHANG, Suzhou (CN); Xiangrui WANG, Suzhou (CN)

(73) Assignee: Rui ZHANG, Suzhou (CN)

(21) Appl. No.: 18/053,761

(22) Filed: Nov. 9, 2022

(51) Int. Cl. H02M 3/06; H05B 1/02; H05B 3/00

(52) U.S. Cl. CPC H02M 3/06; H05B 1/02; H05B 3/0019; H05B 2203/005

(57) ABSTRACT

A quick-charge voltage booster circuit for heating comprises a plurality of heating elements connected in parallel, at least one controller electrically connected with the heating elements, and at least one electrical connector electrically connected with the controller. The electrical connector is configured to connect to an external power source for providing input voltages to the heating elements, the controller is configured to detect an input voltage for each heating element first, and then different input voltages from the external power source are adapted and boosted to a preset value for heating. After invoking the supply voltage of a portable charger, the quick-charge voltage booster circuit provided by the present invention boosts the voltage again internally, thereby the power is higher and the heating effect is better.

### TECHNICAL FIELD

The present disclosure relates to a quick-charge voltage booster circuit for heating.

### BACKGROUND OF THE PRESENT INVENTION

With the development of the electronic technology, users have higher and higher requirements for the heating experience of intelligent heating clothing, home textiles and other products. At present, most of the products that provide heating by means of a portable charger on the market have 10 W (5 V×2 A) power, and don't have a satisfactory heating effect owing to the limitation of the power output from the portable charger. Although some products utilize an 18 W (9 V×2 A) quick charger for heating, they still can't meet people's requirement for an absolute comfortable heating experience.

Most of the portable chargers used in the heating technique employed by the existing intelligent heating products provide power supply at 5 V voltage, and have maximum power of 10 W owing to the current limitation of the portable charger. Although some heating products employ a quick charging technique for heating, almost all of them provide power supply at 9 V voltage and 18 W total power for heating, which are very limited increases. At such power, the heating rate is very low, and good heat insulation is required to attain a good heating effect. Moreover, larger heating elements have a poorer heating effect.

### SUMMARY OF PRESENT INVENTION

The object of the present invention is to provide a quick-charge voltage booster circuit for heating, in order to solve the above technical problems.

To attain the object described above, the present invention employs the following technical scheme:

A quick-charge voltage booster circuit for heating, comprises a plurality of heating elements connected in parallel, at least one controller electrically connected with the heating elements, and at least one electrical connector electrically connected with the controller, wherein the electrical connector is configured to connect to an external power source for providing input voltages to the heating elements, the controller is configured to detect an input voltage for each heating element first, and then different input voltages from the external power source are adapted and boosted to a preset value for heating.

Preferably, in the quick-charge voltage booster circuit for heating, the controller comprises a quick-charge protocol chip, a single-chip microcomputer and a plurality of control circuit units for boosting the voltage differently; the single-chip microcomputer is connected with the quick-charge protocol chip and the control circuit units respectively; adaptive voltages of the plurality of heating elements are different, each of the control circuits is connected with one heating element, and the voltage boosting functions of the control circuits match the adaptive voltages of corresponding heating elements respectively.

Preferably, in the quick-charge boost circuit for heating, once protocol handshaking of the quick-charge protocol chip is completed successfully, the controller outputs 20 V voltage to the heating element for which the protocol handshaking is completed successfully to drive the heating element to generate heat at full power.

Preferably, a type of the quick-charge protocol chip is CH224K.

Preferably, in the quick-charge voltage booster circuit for heating, each of the heating elements is electrically connected with the controller separately and respectively, and capable of heating separately under control of the controller.

Preferably, in the quick-charge voltage booster circuit for heating, the controller is capable of boosting input voltages of the heating elements with different adaptive voltages to different values for heating.

Preferably, in the quick-charge voltage booster circuit for heating, the controller comprises a control circuit unit via which the input voltage from the external power source is boosted to 10 V for heating when the input voltage is 5 V±0.5 V.

Preferably, in the quick-charge voltage booster circuit for heating, the controller comprises a control circuit unit via which the input voltage from the external power source is boosted to 15 V for heating when the input voltage is 9 V.

Preferably, in the quick-charge voltage booster circuit for heating, the control circuit unit is a voltage booster unit, which is a BOOST circuit.

Preferably, in the quick-charge voltage booster circuit for heating, the electrical connector is a type-c interface or USB interface.

With the above technical scheme, the present invention has at least the following advantages:
1. The quick-charge voltage booster circuit provided by the present invention can adapt to a multi-voltage heating system and adapt to more types of power sources selected by the user.
2. The PD quick-charge system provided by the present invention can invoke a higher voltage for heating at higher power.
3. After invoking the supply voltage of a portable charger, the quick-charge voltage booster circuit provided by the present invention boosts the voltage again internally, thereby the power is higher and the heating effect is better.

The above description is only a summary of the technical scheme of the present invention. In order to make the technical means of the present invention understood more clearly and enable implementation of the present invention according to the description, hereunder the present invention will be detailed in preferred embodiments of the present invention with reference to the accompanying drawings.

### DESCRIPTION OF THE DRAWINGS

To make the technical scheme in the embodiments of the present invention understood better, hereunder the accompanying drawings used in the embodiments will be introduced briefly. It should be appreciated that the accompanying drawings described below only illustrate some embodiments of the present invention, and should not be deemed as constituting any limitation to the scope of the present invention. Those having ordinary skills in the art can obtain other related drawings based on these drawings without expending any creative labor.

FIG. 1 is a schematic structural diagram of a quick-charge voltage booster circuit according to an embodiment of the present disclosure;

FIG. 2 is a schematic diagram showing an internal structure of a controller according to an embodiment of the present disclosure;

FIG. 3 is a circuit diagram of a voltage booster unit for detecting different voltages according to an embodiment of the present disclosure;

FIG. 4 is a circuit diagram of a quick-charge chip according to an embodiment of the present disclosure.

### DETAILED DESCRIPTION OF PREFERRED EMBODIMENTS

To make the object, technical scheme, and advantages of the embodiments of the present invention understood more clearly, hereunder the technical scheme in the embodiments of the present application will be detailed clearly and completely, with reference to the accompanying drawings in the embodiments of the present application. Apparently, the embodiments described here are only some embodiments of the present application rather than all possible embodiments of the present application. Generally, the components of the embodiments of the present application described and illustrated in the accompanying drawings herein can be arranged and designed in various different configurations.

Therefore, the following detailed description of the embodiments of the present application provided in the accompanying drawings is not intended to limit the scope of the claimed application, but is only intended to explain the selected embodiments of the present application. Those skilled in the art can obtain other embodiments based on the embodiments provided herein without expending any creative labor; however, all those embodiments shall be deemed as falling in the scope of protection of the present application.

It should be noted that similar numbers and letters represent similar items in the following drawings. Therefore, once an item is defined in one of the drawings, it is not necessary to define and explain it further in the follow-up drawings.

In the description of the present application, it should be noted that the orientational or positional relations indicated by terms such as “vertical”, “horizontal”, “inside”, or “outside”, etc., are based on the orientational or positional relations indicated in the accompanying drawings, or based on the orientational or positional relations in which the product in the present application is usually placed. Those terms are intended only to ease and simplify the description of the present application, instead of indicating or implying that the involved device or element must have a specific orientation or must be constructed and operated in a specific orientation. Therefore, the use of those terms shall not be deemed as constituting any limitation to the present application. Besides, the terms “first” and “second”, etc., are only for a distinguishing purpose, and should not be comprehended as indicating or implying any relative importance.

In addition, the terms such as “horizontal” and “vertical”, etc. do not mean that the components must be absolutely horizontal or vertical; instead, the components may be slightly inclined. For example, “horizontal” only means that the direction is more horizontal than “vertical”, but doesn't mean that the structure is absolutely horizontal, which is to say, the structure may be slightly inclined.

It should also be noted: in the description of the present application, unless otherwise specified and defined explicitly, the terms “provide”, “install”, “interconnect”, and “connect”, etc. shall be interpreted in their general meanings, for example, a connection may be a fixed connection, detachable connection, or integral connection; may be a mechanical connection or electrical connection; or may be a direct connection or indirect connection via an intermediate medium, or internal communication between two elements. Those having ordinary skills in the prior art can understand the specific meanings of the terms in the present application in their context.

### EMBODIMENT

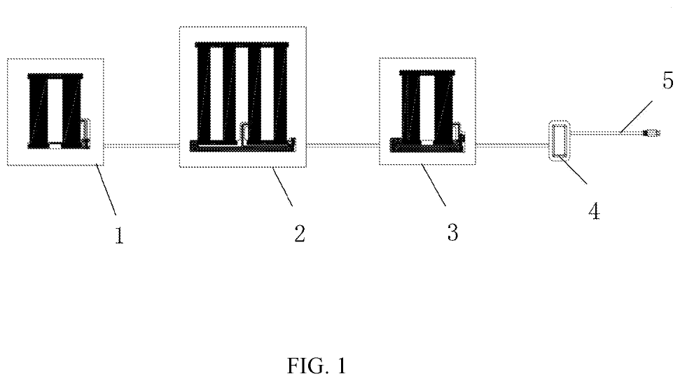

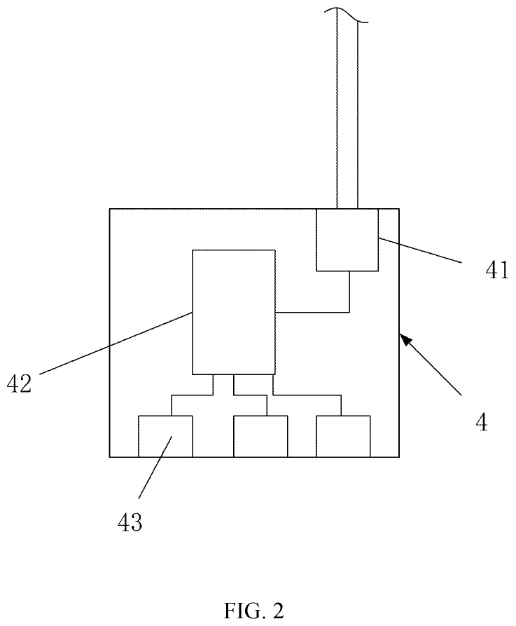

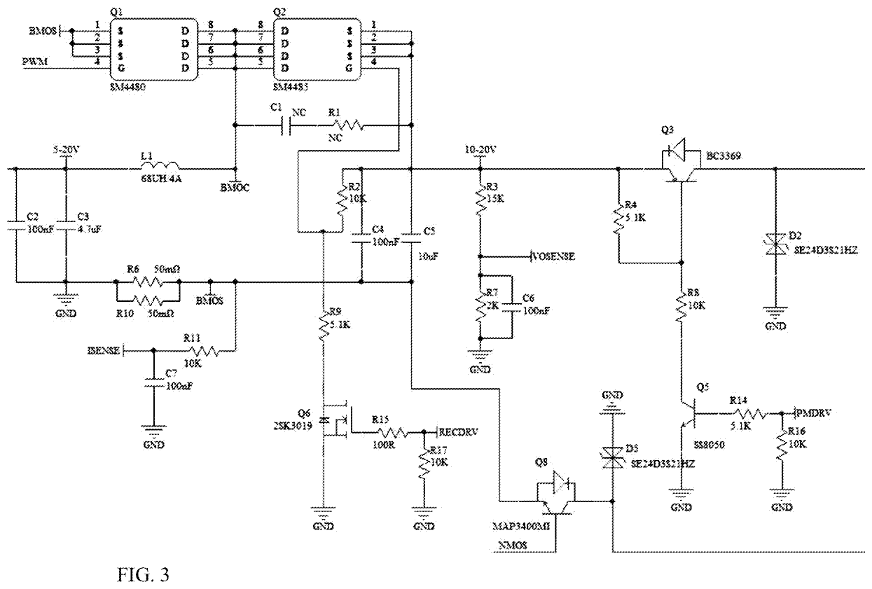

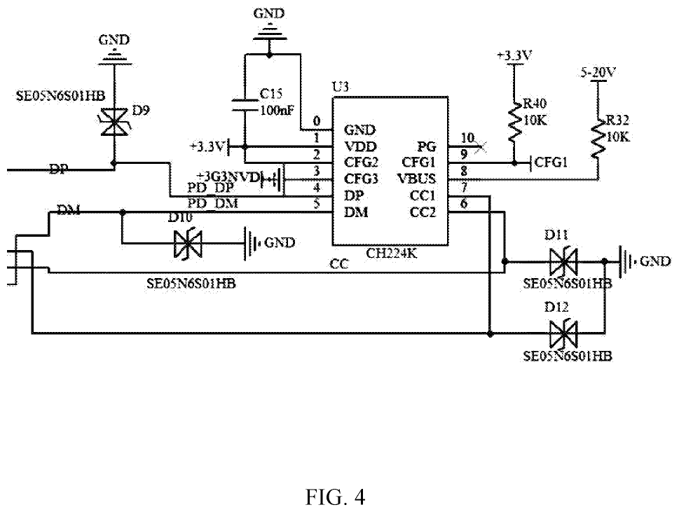

As shown in FIGS. 1-4, a quick-charge voltage booster circuit for heating comprises a plurality of heating elements 1, 2 and 3 connected in parallel, at least one controller 4 electrically connected with the heating elements, and at least one electrical connector 5 electrically connected with the controller 4. When the electrical connector is connected to an external power source for providing input voltages to the heating elements, the controller detects an input voltage for each heating element first, and then boosts different input voltages from the external power source to a preset value for heating via voltage booster units in the controller.

According to embodiment of the disclosure, one controller 4 can be used to complete the corresponding process, but the technical scheme doesn't exclude the possibility that multiple controllers are used for controlling the operation of more heating elements.

According to embodiment of the disclosure, the controller comprises a quick-charge protocol chip 41, a single-chip microcomputer 42 and a plurality of control circuit units 43 having different voltage boosting functions. The single-chip microcomputer is connected with the quick-charge protocol chip and the control circuit units respectively. Adaptive voltages of the plurality of heating elements are different, and the voltage boosting functions of the control circuit units match with the adaptive voltages of the corresponding heating elements respectively.

According to embodiment of the disclosure, once the protocol handshaking of the quick-charge protocol chip is completed successfully, the controller outputs 20 V voltage to the heating element for which the protocol handshaking is completed successfully, so that the heating element is capable of heating at full power.

The controller comprises a control circuit unit via which the input voltage from the external power source is boosted to 10 V for heating when the input voltage is 5 V±0.5 V.

The controller comprises a control circuit unit via which the input voltage from the external power source is boosted to 15 V for heating when the input voltage is 9 V.

The above situations can happen at the same time. Since the heating elements are connected in parallel, the controller can detect them respectively and enable the situations as long as the above conditions are met. The specific input voltage boosting is realized by the BOOST circuit, which is a known boosting technique and not further detailed herein.

According to embodiment of the disclosure, a type of the quick-charge protocol chip is CH224K.

According to embodiment of the disclosure, each of the heating elements is electrically connected with the controller separately and respectively, and capable of heating separately under control of the controller.

According to embodiment of the disclosure, the controller is capable of boosting the input voltages of the heating elements with different adaptive voltages to different values for heating.

According to embodiment of the disclosure, the electrical connector is a type-c interface or USB interface.

While some preferred embodiments of the present invention are described above, the present invention is not limited to those embodiments. It should be noted that those having ordinary skills in the art can make various modifications and variations without departing from the technical principle of the present invention. All of such modifications and variations shall be deemed as falling in the scope of protection of the present invention.

We claim:

1. A quick-charge voltage booster circuit for heating, comprising:
a plurality of heating elements connected in parallel,
at least one controller electrically connected with the heating elements, and
at least one electrical connector electrically connected with the controller, wherein the electrical connector is configured to connect to an external power source for providing input voltages to the heating elements, the controller is configured to detect an input voltage for each heating element first, and then different input voltages from the external power source are adapted and boosted to a preset value for heating.

2. The quick-charge voltage booster circuit for heating according to claim 1, wherein the controller comprises a quick-charge protocol chip, a single-chip microcomputer and a plurality of control circuit units having different voltage boosting functions; the single-chip microcomputer is connected with the quick-charge protocol chip and the control circuit units respectively; adaptive voltages of the plurality of heating elements are different, each of the control circuits is connected with one heating element, and the voltage boosting functions of the control circuits match the adaptive voltages of corresponding heating elements respectively.

3. The quick-charge voltage booster circuit for heating according to claim 2, wherein once protocol handshaking of the quick-charge protocol chip is completed successfully, the controller outputs 20 V voltage to the heating element for which the protocol handshaking is completed successfully to drive the heating element to generate heat at full power.

4. The quick-charge voltage booster circuit for heating according to claim 3, wherein a type of the quick-charge protocol chip is CH224K.

5. The quick-charge voltage booster circuit for heating according to claim 1, wherein each of the heating elements is electrically connected with the controller separately and respectively, and capable of heating separately under control of the controller.

6. The quick-charge voltage booster circuit for heating according to claim 5, wherein the controller is capable of boosting input voltages of the heating elements with different adaptive voltages to different values for heating.

7. The quick-charge voltage booster circuit for heating according to claim 6, wherein the controller comprises a control circuit unit via which the input voltage from the external power source is boosted to 10 V for heating when the input voltage is 5 V±0.5 V.

8. The quick-charge voltage booster circuit for heating according to claim 6, wherein the controller comprises a control circuit unit via which the input voltage from the external power source is boosted to 15 V for heating when the input voltage is 9 V.

9. The quick-charge voltage booster circuit for heating according to claim 2, wherein each of the control circuit units is a voltage booster unit, which is a BOOST circuit.

10. The quick-charge voltage booster circuit for heating according to claim 7, wherein the control circuit unit is a voltage booster unit, which is a BOOST circuit.

11. The quick-charge voltage booster circuit for heating according to claim 8, wherein the control circuit unit is a voltage booster unit, which is a BOOST circuit.

12. The quick-charge voltage booster circuit for heating according to claim 1, wherein the electrical connector is a type-c interface or USB interface.
